(19) United States
(12) Patent Application Publication
(10) Pub. No.: US 2017/0032352 A1
(43) Pub. Date: Feb. 2, 2017

(54) INTEGRATION OF EXTENDED COMPUTER SYSTEM FUNCTIONALITY

(71) Applicant: Klarna AB, Stockholm (SE)

(72) Inventors: Koen Koeppen, Stockholm (SE); Frank Hoffmann, Stockholm (SE)

(21) Appl. No.: 14/952,153

(22) Filed: Nov. 25, 2015

Related U.S. Application Data
(60) Provisional application No. 62/197,498, filed on Jul. 27, 2015.

(51) Int. Cl. G06Q 20/24; G06Q 20/36; G06Q 20/40; G06Q 30/06; G06Q 20/34

(52) U.S. Cl. CPC G06Q 20/24; G06Q 30/0635; G06Q 20/351; G06Q 20/409; G06Q 20/363

(57) ABSTRACT

The disclosed systems and methods efficiently integrate an external payment provider's functionality into an existing merchant's electronic order pipeline. For example, an existing merchant order pipeline may include one or more input pages for information such as customer credit card number, shipping address, shipping method specification, addressee, and the like. The techniques described allow such input pages, as well as the underlying systems handling order fulfillment at the merchant level, to remain intact with little or no manipulation required for integration of a third party (external) payment provider.

### BACKGROUND

As computers and computer networks become ubiquitous, more and more transactions are being conducted over computer networks. Various mechanisms and procedures have been implemented in order to make such transactions secure, to facilitate order processing workflows, to accept new forms of payment, and the like. Many entities implementing such mechanisms and procedures may update them less frequently than, for example, an external payment provider. However, as different entities may have differing underlying order fulfillment triggers, processes, and the like, integration of an external payment provider's systems into an existing entity's order fulfillment pipeline and other existing workflows can be complex, time-consuming, and occasionally counterproductive with respect to improving security, efficiency, and other metrics.

### BRIEF DESCRIPTION OF THE DRAWINGS

Various embodiments in accordance with the present disclosure will be described with reference to the drawings, in which:

FIG. 1 illustrates integration and interaction of one or more external payment provider inputs with a merchant order pipeline, in accordance with some embodiments;

FIG. 2 illustrates an example environment in which a merchant system and an external payment provider interact, in accordance with some embodiments;

FIG. 3 illustrates example workflows for order entry information using an external payment provider integrated with a merchant order pipeline, in accordance with some embodiments;

FIG. 4 illustrates implementation of a listener to synchronize merchant order updates with an external payment provider, in accordance with some embodiments;

FIG. 5 illustrates integration of an external payment provider to facilitate order processing by an order aggregator in a multi-merchant environment, in accordance with some embodiments;

FIG. 6 illustrates an example process for processing order creation using an existing merchant order pipeline integrated with an external payment provider, in accordance with some embodiments;

FIG. 7 illustrates an example process for monitoring merchant system activity to synchronize order updates with an integrated external payment provider, in accordance with some embodiments;

FIG. 8 illustrates an example process for issuing a plurality of virtual credit cards in connection with a multi-merchant environment in which an order aggregator operates, in accordance with some embodiments; and

FIG. 9 illustrates a computing device that may be used in accordance with at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Techniques described and suggested in the present disclosure include systems and methods for efficiently extending the functionality of a computer system by integrating, into the computer system, functionality of another. Example applications of the techniques described and suggested herein involve integration of an external payment provider's automated payment system functionality into a merchant's existing electronic order pipeline. For example, an existing merchant order pipeline may include one or more input pages allowing for entry of information such as customer credit card number, shipping address, shipping method specification, addressee, and the like. The techniques described allow such input pages, as well as the underlying systems handling order fulfillment at the merchant level, to remain intact with little or no manipulation (e.g., reprogramming) required for integration of a third party (external) payment provider.

In some embodiments, an entry point for the merchant order pipeline, such as a “checkout” or “buy” button in the user interface, is modified so as to entirely or partially redirect a remote user (e.g., a user wishing to purchase one or more items and thus clicking on the “checkout” or “buy” button) to the input pages of an external payment provider, rather than providing the remote user with the existing order entry interface originally provided by the merchant within the previously unmodified merchant order pipeline (e.g., a webpage wherein a remote user may enter shipment and payment details). The external payment provider inputs may be presented to the remote user in any appropriate fashion, such as by overlaying and/or obscuring the interface from which they were invoked, by appearing in a separate window (e.g., a popup), and the like. Furthermore, information regarding the proposed order may be passed to the external payment provider for further processing. For example, order information (e.g., total prices, provisional order number, item quantity and identification information), customer information (e.g., if the remote user had already authenticated a pre-existing customer account prior to entering the order pipeline), and the like, is provided to the external payment provider at the time of order pipeline entry.

In some embodiments, information provided by the remote user to the external payment provider inputs is verified by the implementing external payment provider's automated payment system. Such verification processes may be similar to those already implemented by the merchant, and, in some embodiments, extend the merchant's existing payment functionality in a fashion that would otherwise be time consuming or technically difficult for the merchant to achieve. The verification processes may include verification of sufficient funds, address verification, verification of shipment and payment method validity, and the like. After verification, the external payment provider obtains one or more virtual credit card authorizations from a virtual credit card provider, and maps one or more identifiers associated with the provisional order to the obtained virtual credit card(s). Such associations may be stored as records, e.g., on a data store, for future retrieval, processing, and other use.

In some embodiments, the virtual credit card information, along with some or all of the information inputted by the remote user into the external payment provider inputs, is provided to a spider entity that is capable of populating one or more existing order entry pages originally provided by the merchant in its legacy order pipeline. In some of such embodiments, the spider enters the information into the appropriate places on the legacy interface, and causes the submission of the order into the merchant system using, e.g., the virtual credit card information attained by the external payment provider, in a similar fashion as would have otherwise been achieved directly by the remote user. Accordingly, in such embodiments, the submitted order is subject to the ordinary verifications already put in place by the merchant, and little or no modification to such systems by the merchant is required as the information provided is effectively complete. In some embodiments, so as to improve the acceptance rate of orders so submitted, various merchant-side verifications may be mocked or otherwise disabled, as they may be duplicative of verifications just performed by the external payment provider.

The spider itself may be an entity, such as a script, that, when executed, causes an executing computer system (e.g., user device) to retrieve or receive information from the external payment provider and determine where in the merchant order pipeline interface such information should be entered. In some embodiments, the spider provides translation from one data format to another (e.g., from raw data from the external payment provider to a data format that the merchant order pipeline is capable of processing). In some embodiments, the spider is integrated into the client-side interface (as part of an initial integration, for instance), or, in other embodiments, is implemented as an entity by the external payment provider (e.g., in the external payment provider input interface).

If the merchant order pipeline and various verifications accepts the submitted order, order processing by the merchant proceeds as normal. However, it may be contemplated that various payment-related actions associated with the order, such as payment settlement, dispatching of the order, refunds, returns, and the like, may be performed with respect to the virtual credit card previously submitted by the external payment provider, and not necessarily the remote user's actual method of payment. In some embodiments, a listener entity is implemented to track the various states of an order with respect to the virtual credit card, and if such events occur, the listener or other connected entity submits information regarding the events to the external payment provider so as to synchronize such events with the actual payment instrument used. Additionally, various states may be inferred by certain events occurring in connection with the virtual credit card, such as date of dispatch, inventory levels (due to returns and the like), etc.

In some embodiments, an order aggregator may integrate one or more of the techniques described, including the provision and dissemination of virtual credit cards, so as to facilitate single point source ordering in a multi-merchant environment. For example, existing fraud verifications may disallow multiple orders on a given credit card within a short period of time, thereby causing problems when a remote user attempts to use an order aggregator to purchase items from multiple disparate merchants in a single order. The external payment provider, if integrated into the order aggregator's order pipeline, may provide multiple virtual credit cards to be disseminated to the disparate merchants, and track such dissemination against a single method of payment as provided by the remote user.

Techniques described and suggested in the present disclosure improve the field of computing, specifically the field of electronic payment processing, by improving ease of security updates and other functionalities into a large and diverse array of legacy payment processing systems, without necessitating deep integration into such legacy systems beyond that of the presentation layer. Additionally, techniques described and suggested in the present disclosure improve the efficiency of electronic payment processing methods by utilizing computer-generated virtual credit cards to slipstream technological improvements associated with electronic payment processing without directly implementing such technological improvements into a legacy electronic payment system that may not otherwise be capable of supporting them. The problem of integrating an electronic order pipeline with that of a disparate electronic payment provider, is necessarily technological in nature, and includes modification of programmatic interfaces, translation of data formats, and the like, and the improvements described herein also rely on technologies that are inherently technological (such as virtual credit cards and input spiders).

Techniques described and suggested herein allow for such online payment systems to operate more efficiently and in a manner that addresses many of the cumbersome aspects of electronic payment entry, integration, and processing, thereby making such online payment systems easier to use. Further, many organizations employ complex systems to customize user interfaces, such as web pages. Techniques described and suggested herein allow for more efficient and/or more effective customization of such user interfaces, including user interfaces for online payment systems.

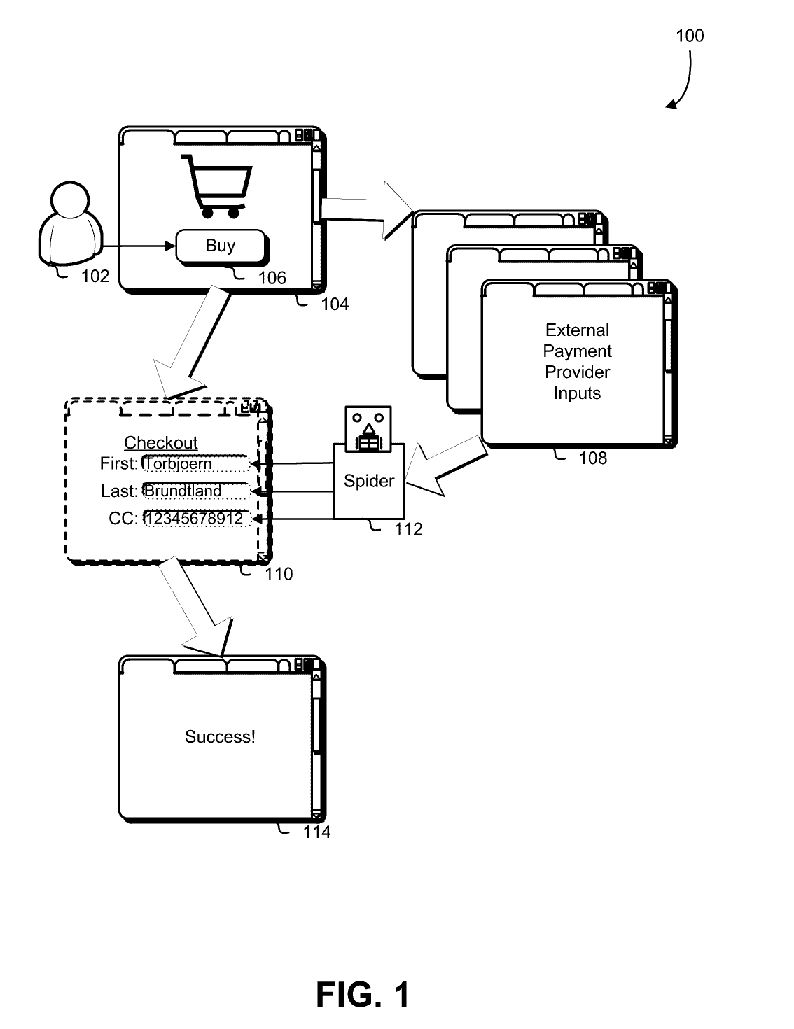

FIG. 1 illustrates integration and interaction of one or more external payment provider inputs 108 with a merchant order pipeline 104, 110, 114, in accordance with some embodiments. For example, an existing merchant order pipeline 104, 110, 114 may include one or more input pages (e.g., 110) for information such as customer credit card number, shipping address, shipping method specification, addressee, and the like. The techniques described allow such input pages (and by extension the merchant's order pipeline as a whole), as well as the underlying systems handling order fulfillment at the merchant level, to remain intact with little or no manipulation required for integration of a third party (external) payment provider.

The merchant order pipeline may be any series of interfaces, such as user interfaces, that are presented to a requestor (such as a customer) so as to interact with the requestor to present and receive information related to submitting orders for, e.g., goods, services, and the like. The order pipeline is, in some embodiments, sequential in nature. For example, the order pipeline includes one or more user interfaces 104, 110, 114 that allow interaction between a device of the remote user 102. The user interfaces may include one or more electronic documents, such as web pages (either statically constructed or dynamically generated, based on the context from which they were generated), application user interfaces, and the like. The user interfaces may be constructed using one or more structured markup languages, such as Extensible Markup Language (XML), Hypertext Markup Language (HTML), Extensible Hypertext Markup Language (XHTML), and the like. In embodiments where one structured markup language is used, a style language, such as Cascading Style Sheets (CSS), may be used to define the presentation of the structured document generated therefrom and subsequently presented to the remote user via its user device. The user interfaces may integrate one or more scripts or other applications (e.g., applets), constructed in a different language and/or format than that of the parent interface. Examples include the integration of Javascript scripts, Java applets, PHP scripts, and applications executed on a server (e.g., of the merchant system) and presented through the user interface through, e.g., a Common Gateway Interface (CGI) environment. The user interfaces may include application user interfaces that, in some embodiments, are generated by an application operated on a mobile device of the remote user, such as a smartphone, tablet, smartwatch, laptop computer, or the like. A remote user 102 may, by way of its user device, interact with the user interfaces 104, 100, 114 via input fields, buttons, selectors, and the like on the user interfaces.

The remote user 102 may, as mentioned, use a user device to interact with the merchant system, an external payment provider, and the like, such as through a network. The user device may be any computing device capable of interacting therewith. Examples include personal digital assistants, smartphones or other handheld computing devices, laptop computers, tablet computers, virtual machines (e.g., of a distributed system), smartwatches, and the like.

In some embodiments, the merchant order pipeline 104, 110, 114, is provided by a merchant system, such as a merchant system 210 described in further detail below. An entry point 106 for the merchant order pipeline, such as a “checkout” or “buy” button in the user interface (e.g., in connection with an item detail page or shopping cart summary page), may be modified so as to entirely or partially redirect, e.g., a browser on a user device of the remote user 102 (e.g., a user wishing to purchase one or more items and thus clicking on the “checkout” or “buy” button, and/or as further described below) to the input pages 108 of an external payment provider, rather than providing the remote user with the existing order entry interface 110 originally provided by the merchant within the previously unmodified merchant order pipeline (e.g., a webpage wherein a remote user may enter shipment and payment details). For example, activation of the “buy” button by, e.g., the remote user 102 via its user device, may cause the user interface to fully direct the user device to display the input pages 108 of the external payment provider. As another example, activation of the “buy” button may cause the user interface to direct only a portion of the merchant page to the input pages 108, thereby leaving the remainder of the merchant page (or the entire merchant page, in the case where the input pages are rendered in a “popup” or as an overlay of the merchant page) still active (but potentially in the background) on the remote user's device.

The external payment provider inputs may be presented to the remote user via its user device in any appropriate fashion, such as by overlaying and/or obscuring the interface from which they were invoked, by appearing in a separate user interface window (e.g., a popup), and the like. As another example, the external payment provider inputs may be provided in the form of a widget integrated into a designated space on one or more pages of the merchant order pipeline. The original order/payment entry page 110 may be also be rendered by, e.g., a remote user's device or browser, but in some embodiments, the rendering will occur so as to not display the page 110 to the remote user 102. In such embodiments, the rendered page 110 is still available for data entry by, e.g., a spider 112, as discussed in greater detail below.

Furthermore, information regarding the proposed order may be passed to the external payment provider for further processing. For example, order information (e.g., total prices, provisional order number, item quantity and identification information), session information, customer information (e.g., if the remote user had already authenticated a pre-existing customer account prior to entering the order pipeline), and the like, may be provided to the external payment provider at the time of order pipeline entry. The exact data provided may vary from implementation to implementation, and in some cases may vary from order to order, and the transfer of such data may be triggered (e.g., pushed) synchronously to the external payment provider in connection with a remote user's engagement of the entry point 106.

In some embodiments, information provided by the remote user 102 to the external payment provider inputs 108 is verified by the external payment provider providing the input pages 108. Such verification processes may be similar to those already implemented by the merchant, and, in some embodiments, may extend the merchant's existing payment functionality in a fashion that would otherwise be time consuming or technically difficult for the merchant to achieve. The verification processes may include verification of sufficient funds, address verification, verification of shipment and payment method validity, and the like.

After verification, the external payment provider (e.g., 212, described in further detail below) obtains one or more virtual credit card authorizations from a virtual credit card provider (e.g., 214, described in further detail below), and maps one or more identifiers associated with the provisional order to the obtained virtual credit card(s). Such associations may be stored as records, e.g., on a data store (e.g., 406), for future retrieval, processing, and other use.

In some embodiments, the virtual credit card information, along with some or all of the information inputted by the remote user into the external payment provider inputs 108, is provided to a spider entity 112 that is capable of populating one or more existing order entry pages 110 originally provided by the merchant in its order pipeline. In some of such embodiments, the spider 112 enters the information into the appropriate input fields or other input provisions on the legacy interface, and causes the submission of the order into the merchant system using, e.g., the virtual credit card information attained by the external payment provider, in a similar fashion as would have otherwise been achieved directly by the remote user 102. The spider 112 may, for example, interact with the legacy interface by interacting with one or more external interfaces of a browser operating on the remote user's device. The spider 112 may thereby cause submission of the information by emulating, via the external interfaces just mentioned (which may include specified application programming interfaces (APIs) or other “hooks,” such as may be defined for each element, e.g., input field, button, etc., in the markup language or other structure of the electronic document from which the user interface was generated), the direct entry of that information. In a similar manner, the spider 112 may emulate a mouse click or other activation by activating the hook for the user interface element to be activated (e.g., that of the “submit” button).

Accordingly, in such embodiments, the submitted order is subject to the ordinary verifications already put in place by the merchant, and little or no modification to such systems by the merchant is required as the information provided is effectively complete. In some embodiments, so as to improve the acceptance rate of orders so submitted, various merchant-side verifications may be mocked or otherwise disabled, as they may be duplicative of verifications just performed by the external payment provider. For example, the order pipeline 104, 110, 114 may be modified so as to mock or disable address verification on the merchant side.

The spider 112 itself may be an entity, such as a script, that, when executed by, e.g., a computing device configured to do so, retrieves or receives information from the external payment provider and determines where in the merchant order pipeline interface such information should be entered. For example, the spider 112 may be an application (e.g., a binary) operating on the server of either (or both) the merchant system and/or the external payment provider's system. As another example, the spider 112 may be a script, such as a Javascript script, that is referenced or embedded into the user interface from which it is called, such as the merchant's order pipeline and/or the external payment provider's pipeline. In some embodiments, the spider 112 may provide translation from one data format to another (e.g., from raw data from the external payment provider to a data format that the merchant order pipeline is capable of processing). For example, the spider 112 may include instructions that cause an implementing computing device to ingest plain text data of one character set or locale, such as those received by the external payment provider's pipeline, and, after detecting the codepage, locale, or character set of the receiving entity (or, e.g., that of the browser rendering such data), generating the corresponding output in the detected codepage, locale or character set so as to effectively enter the data into the merchant's order pipeline (e.g., via the remote user's device).

In some embodiments, the spider 112 may be integrated into the client-side interface (as part of an initial integration, for instance), or, in other embodiments, may be implemented as an entity by the external payment provider (e.g., as a script or other module of the external payment provider input interface 108). In some embodiments, the spider may have a programmatic interface, such as an application programming interface (API), and various operational parameters, such as operating character set, user agent, and the like, may be manipulated by, e.g., the external payment provider via programmatic calls thereby.

If the merchant order pipeline and various verifications accepts the submitted order, order processing by the merchant proceeds as normal, and in some embodiments, a record of the submitted order is stored in a data store for later reference and/or further processing. An indication of success 114 is presented to the remote user 102 via its user device. In some embodiments, as the spider 112 acts as the user agent for entering the payment information in entry page 110, one or more implementations may require a capture of the redirect to the “success” page 114 so as to redirect the success page 114 to the device of the remote user 102, rather than attempting to render it to the spider 112 or associated computing device.

After an order is successfully submitted according to the above mentioned processes, various payment-related actions associated with the order, such as payment settlement, dispatching of the order, refunds, returns, and the like, may occur with respect to the virtual credit card previously submitted by the external payment provider, and not necessarily the remote user's actual method of payment. In some embodiments, as described in further detail below, a listener entity is implemented to track the various states of an order with respect to the virtual credit card, and if such events occur, the listener or other connected entity submits information regarding the events to the external payment provider so as to synchronize such events with the actual payment instrument used. Additionally, various states may be inferred by certain events occurring in connection with the virtual credit card, such as date of dispatch, inventory levels (due to returns and the like), etc.

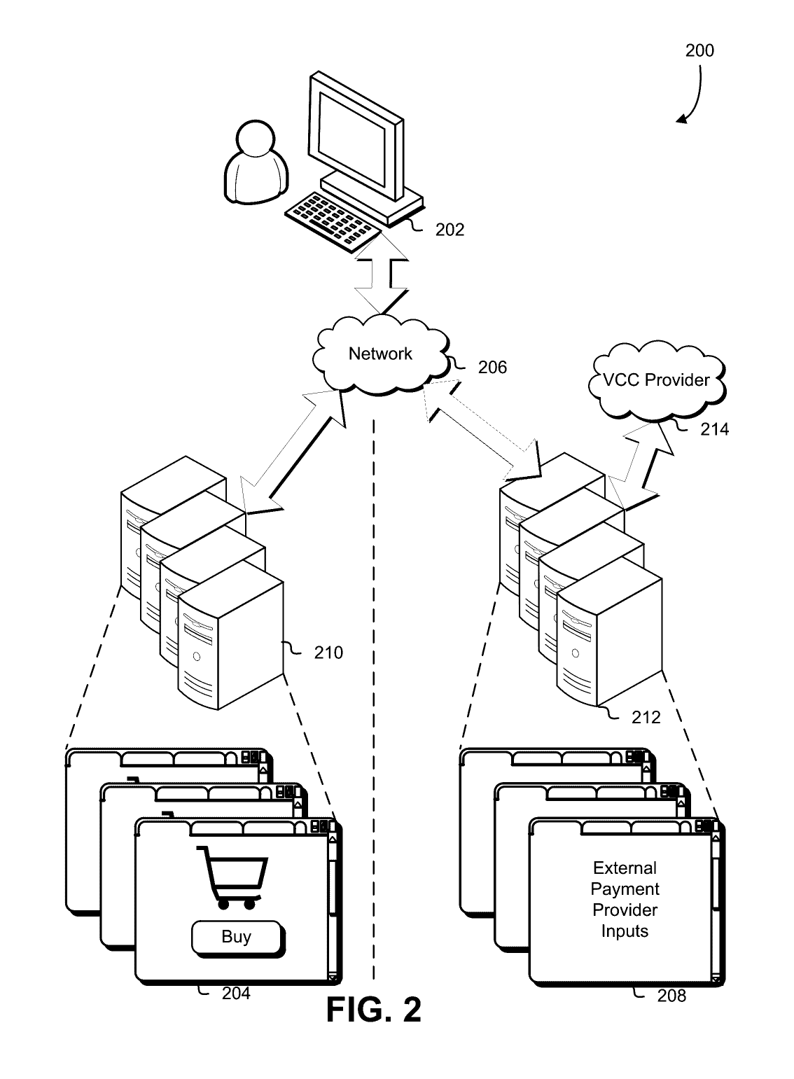

FIG. 2 illustrates an example environment in which a merchant system and an external payment provider interact, in accordance with some embodiments. As illustrated in FIG. 2, the system 200 may be configured to facilitate a transaction, by way of communications over at least one network 206, between a remote user 202 and a merchant system 210. The merchant system 210 may include at least one server in communication with, e.g., a user device of the remote user 202 through the network 206.

The remote user 202 may be an individual attempting to purchase an item or service from the merchant corresponding to the merchant system 210. As noted, embodiments of the present disclosure can be implemented in other contexts; for example, the remote user 202 may be a user attempting to register or authenticate as a user of a media website hosted by the merchant system 210. As illustrated in FIG. 2, the remote users 202 may access, through the network 206, a website, such as an online marketplace, that is hosted on at least one server associated with the merchant system 210. The hosted website may include a merchant order pipeline 204, which includes one or more interfaces (e.g., webpages or user interfaces and related states of an application, such as a mobile application) for accepting and displaying various order- and payment-related information, such as address information, shipping details, payment information (e.g., credit card information), order contents (e.g., item description and quantity), and the like.

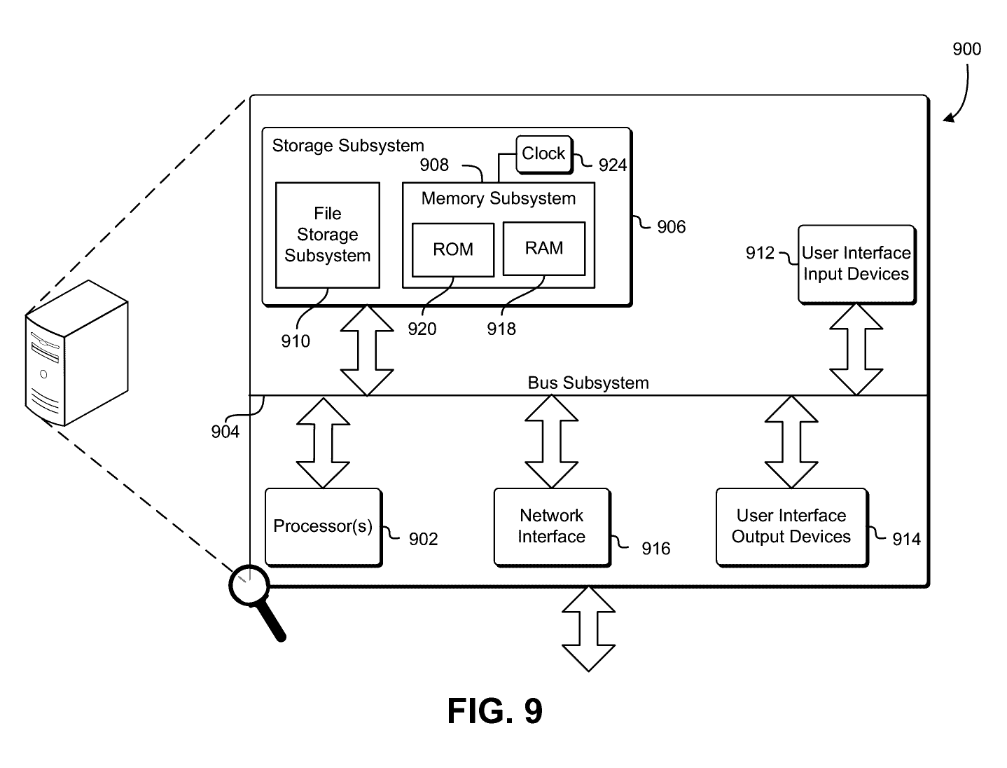

The remote user 202 may include a user device, and may be an electronic computing device, such as a personal computer, mobile device, tablet computer, home theater device, or a device similar to the device 900 of FIG. 9, configured to communicate with sites like the website of the merchant system 210, such as through a browser and/or application programming interface. The network 206 represents the path of communication between the remote user 202 and merchant system 210 and/or the external payment provider 212. Examples of the network 206 include the Internet, a local area network, a wide area network and Wi-Fi.

The merchant system 210 may include one or more computing devices, such as that described in connection with FIG. 9 below, that are capable of receiving, processing, and disseminating order-related information. The merchant system 210 may include a plurality of servers, as mentioned, and, in some embodiments, may be a distributed merchant system. The merchant system 210 may include various services and components, some or all of which may include either or both user or programmatic interfaces for interaction therewith. Examples of such services and components may include entities related to payment processing, inventory management, order fulfillment, supply chain management, customer account management, and the like. Some or all of such services may be capable of interacting with entities outside of the merchant system 210, such as the remote user 202 and the external payment provider 212.

The merchant system 210 may include, as mentioned, a website or other Internet-accessible platform configured to provide goods and/or services to customers at a price. Note that although the system 200 is described in the context of an online marketplace, it is contemplated that the system may be usable in other contexts. For example the merchant system, rather than being an online marketplace, may be a system hosting a social media site, a news site, or other site configured to perform operations based on the identity of the remote user 202.

The merchant system 210, as well as the external payment provider 212, may include one or more data stores, such as databases. Such data stores are capable of storing an organized collection of data, such as tables, queries, reports, views, and other objects. The data stores may be configured for the storage and retrieval of data for the merchant system 210 and/or the external payment provider 212. For example, merchant system 210 data stores may include, among other things, information about the products being sold by the merchant, such as quantity in stock, price, description, images of the products, and so on. The merchant system 210 may be configured to host a website and/or other applications for the merchant. The data stores may also be a repository for historical information, such as details about past orders, identifiers for customers who have previously purchased something from the merchant, and other such information. Examples of such repositories include those commercially available from Oracle®, Microsoft®, Sybase®, and IBM® as well as open-source repositories such as MySQL, Postgres, SQLite, MongoDB, and any other repository capable of storing, retrieving, and accessing structured or unstructured data.

The external payment provider 212 may, as with the merchant system 210, include one or more computing devices, such as that described in connection with FIG. 9 below, that are capable of receiving, processing, and disseminating order-related information. The external payment provider 212 may include a plurality of servers, as mentioned, and, in some embodiments, may be a distributed system. The external payment provider 212 may include various services and components, some or all of which may include either or both user or programmatic interfaces for interaction therewith. As with the merchant system 210, examples of such services and components may include entities related to payment processing, inventory management, order fulfillment, supply chain management, customer account management, and the like. In some embodiments, the external payment provider may have vestigial or “stub” versions of some of such entities, so as to more efficiently interface with merchant systems (e.g., merchant system 210) having fully functional forms of the entities. The external payment provider 212 may provide a user interface and/or a programmatic interface, such as external payment provider inputs 208, that are capable of directly or indirectly receiving and/or disseminating payment-related information, such as user identification, credit card numbers, billing addresses, and the like. Some or all of such services may be capable of interacting with entities outside of the external payment provider 212, such as the remote user 202, the virtual credit card provider 214, and the merchant system 210.

The virtual credit card provider 214 may be any entity capable of disseminating virtual credit card numbers that are capable of being fully authenticated by a credit card-capable system. The virtual credit card provider 214 may be remote to the external payment provider 212, and they may be interconnected by way of, e.g., the network 206. The external payment provider 212 and the virtual credit card provider 214 may interact via a programmatic interface, such as a web service call or an application programming interface (API), provided by the virtual credit card provider 214. For example, the virtual credit card provider 212 may provide an API to the external payment provider 212, through which the external payment provider 212 may submit requests for provision of virtual credit card numbers. In response, in either asynchronous or synchronous fashion with respect to the request, the virtual credit card provider 212 may provide one or more virtual credit card numbers. The virtual credit card provider 212 may perform one or more verification checks, such as for validity of the requesting party, validity of request formation, and the like, incident to (e.g., prior to approving and providing) the request and subsequent provision of virtual credit card number(s). In some embodiments, both the external payment provider 212 and the virtual credit card provider 214 are independently capable of issuing credit card numbers, such as virtual credit card numbers, and in some of such embodiments, the external payment provider 212 and the virtual credit card provider 214 are separate technological entities.

The virtual credit card numbers themselves may be mapped and/or mappable to one or more actual issued credit cards, and may be capable of being assigned a monetary value up to which a requesting system may authorize the virtual credit card. The virtual credit card provider 214 may assign the virtual credit cards to a requesting system such that the virtual credit cards expire after a given number of uses, a given length of time, and/or after the authentication amount has been reached.

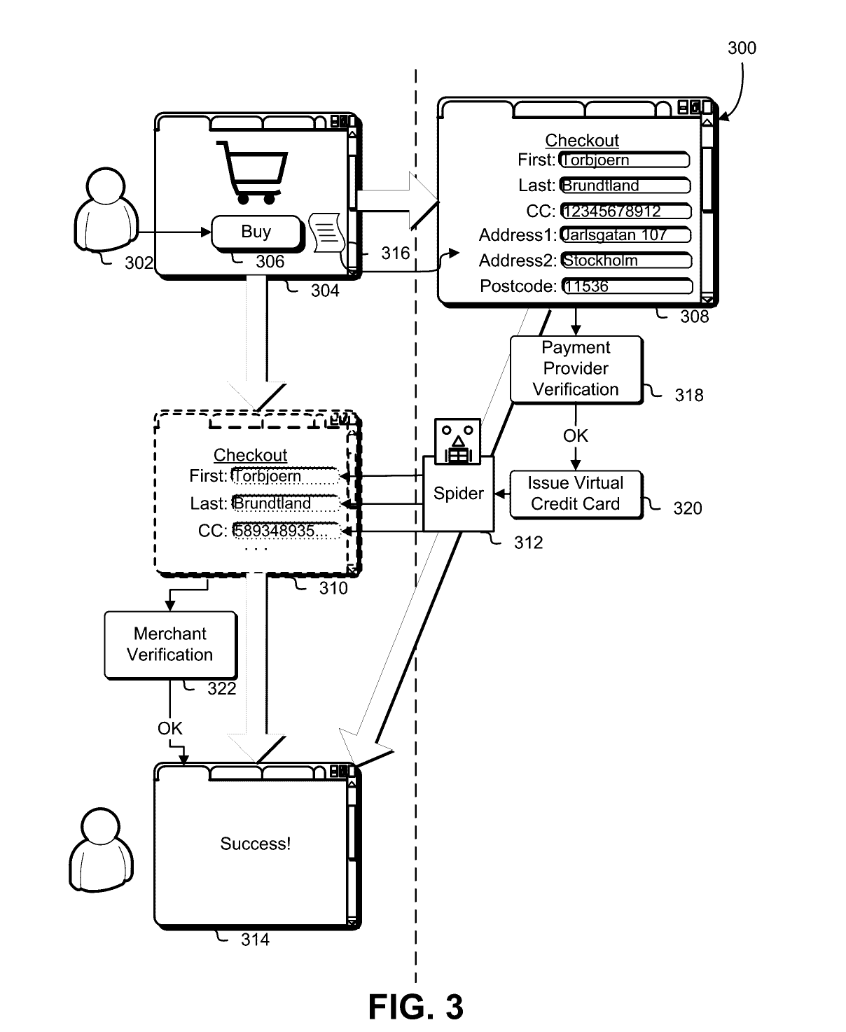

FIG. 3 illustrates example workflows for order entry information using an external payment provider integrated with a merchant order pipeline, in accordance with some embodiments. Similarly to described in connection with FIG. 1, an existing merchant order pipeline 304, 310, 314 may include one or more input pages (e.g., 310) for information such as customer credit card number, shipping address, shipping method specification, addressee, and the like. As previously mentioned, the techniques described allow such input pages (and by extension the merchant's order pipeline as a whole), as well as the underlying systems handling order fulfillment at the merchant level, e.g., various merchant verification processes 322, to remain intact with little or no manipulation required for integration of a third party (external) payment provider.

As previously discussed, the merchant order pipeline 304, 310, 314, along with various merchant order verification processes and entities 322, is provided by a merchant system, such as a merchant system 210 described above. An entry point 306 for the merchant order pipeline, such as a “checkout” or “buy” button in the user interface (e.g., in connection with an item detail page or shopping cart summary page), may be modified, e.g., by the external payment provider, to incorporate a script 316 so as to entirely or partially redirect the remote user 302 (e.g., a user wishing to purchase one or more items and thus clicking on the “checkout” or “buy” button, and/or as further described below) to the input pages 308 and payment workflow (collectively, 308, 318, 320) of an external payment provider, rather than providing the remote user with the existing order entry interface 310 originally provided by the merchant within the previously unmodified merchant order pipeline (e.g., a webpage wherein a remote user may enter shipment and payment details). The script 316 may be of any appropriate form and implemented using any appropriate programming language or other framework. For example, the script 316 may be a Javascript script that is activated in connection with the activation of the entry point 306 (e.g., by clicking). The script 316 used to redirect the remote user to the external payment provider input pages 308 may also be used for other purposes, such as those discussed in greater detail herein.

Upon redirect or activation, the external payment provider inputs 308 may be presented to the remote user in any appropriate fashion, such as by overlaying and/or obscuring the interface from which they were invoked, by appearing in a separate window (e.g., a popup), and the like. As illustrated by the large arrow, the remote user 302 visually observes a transition from the initial page of the merchant's order pipeline 304 to the initial page of the external payment provider's input pages 308 (e.g., payment workflow). However, in some embodiments, the original order/payment entry page 310 (e.g., a subsequent, possibly second page of the merchant's order pipeline) may be also be rendered by, e.g., a remote user's device or browser. In some of such embodiments, the rendering will occur so as to not visibly display the page 310 to the remote user 302. However, in such embodiments, the rendered page 310 is still available for data entry by, e.g., a spider 312, as discussed in greater detail below.

As previously mentioned, information regarding the proposed order may be passed from the merchant side (e.g., via script 316) to the external payment provider for further processing. For example, order information (e.g., total prices, provisional order number, item quantity and identification information), session information, customer information (e.g., if the remote user had already authenticated a pre-existing customer account prior to entering the order pipeline), and the like, may be provided to the external payment provider at the time of order pipeline entry. The exact data provided may vary from implementation to implementation, and in some cases may vary from order to order, and the transfer of such data may be triggered (e.g., pushed) synchronously to the external payment provider in connection with a remote user's engagement of the entry point 306. In some embodiments, some or all of such information passed from the merchant to the external payment provider may be used to prepopulate some or all inputs within the external payment provider's payment pipeline, e.g., input page 308. In some embodiments, a record matching service may be used to disambiguate incomplete information provided to the external payment provider. The record matching service is described in further detail, along with various other techniques, systems, and methods, in pending U.S. Patent Application No. 62/187,620, the entirety of which (including all appendices attached thereto) is hereby incorporated by reference.

In some embodiments, information provided by the remote user 302 to the external payment provider inputs 308, directly, via transfer from the merchant's order pipeline, or both, is verified 318 by the external payment provider. Such verification processes may be similar to those already implemented by the merchant, and, in some embodiments, may extend the merchant's existing payment functionality in a fashion that would otherwise be time consuming or technically difficult for the merchant to achieve. The verification processes may include verification of sufficient funds, address verification, verification of shipment and payment method validity, and the like.

After verification, the external payment obtains one or more virtual credit card authorizations 320 from a virtual credit card provider (e.g., 214, described in further detail above), and maps one or more identifiers associated with the provisional order to the obtained virtual credit card(s). Such associations may be stored as records, e.g., on a data store (e.g., 406), for future retrieval, processing, and other use. The identifiers may include order numbers, customer credit card numbers (e.g., those used to actually charge the remote user 302), and/or arbitrary identifiers generated and/or selected by either the merchant or the payment provider.

After retrieval of the virtual credit card information 320, in some embodiments, the virtual credit card information, along with some or all of the information inputted by the remote user into the external payment provider inputs 308, is provided to a spider entity 312 that, when executed by a computing device, is capable of populating one or more existing order entry pages 310 originally provided by the merchant in its order pipeline (and which, as previously mentioned, may be rendered but not visible to the remote user 302). In some of such embodiments, the spider 312 enters the information into the appropriate places on the legacy interface (e.g., on page 310), and causes the submission of the order into the merchant system using, e.g., the virtual credit card information 320 attained by the external payment provider, in a similar fashion as would have otherwise been achieved directly by the remote user 302. Accordingly, in such embodiments, the submitted order is subject to the ordinary verifications 322 already put in place by the merchant, and little or no modification to such systems by the merchant is required as the information provided is effectively complete. In some embodiments, so as to improve the acceptance rate of orders so submitted, various merchant-side verifications may be mocked or otherwise disabled, as they may be duplicative of verifications just performed by the external payment provider. For example, the order pipeline 304, 310, 314 may be modified so as to mock or disable address verification on the merchant side.

If the merchant order pipeline and its related verifications 322 accept the submitted order, order processing by the merchant proceeds as normal, and in some embodiments, a record of the submitted order is stored in a data store for later reference and/or further processing (e.g., data store 404, described in further detail below). An indication of success 314 is presented to the remote user 302. In some embodiments where the spider 312 acts as the user agent for entering the payment information in entry page 310, a script (e.g., script 316) captures the redirect to the “success” page 314 so as to redirect the success page 314 to the remote user 302, rather than attempting to render it to the spider 312.

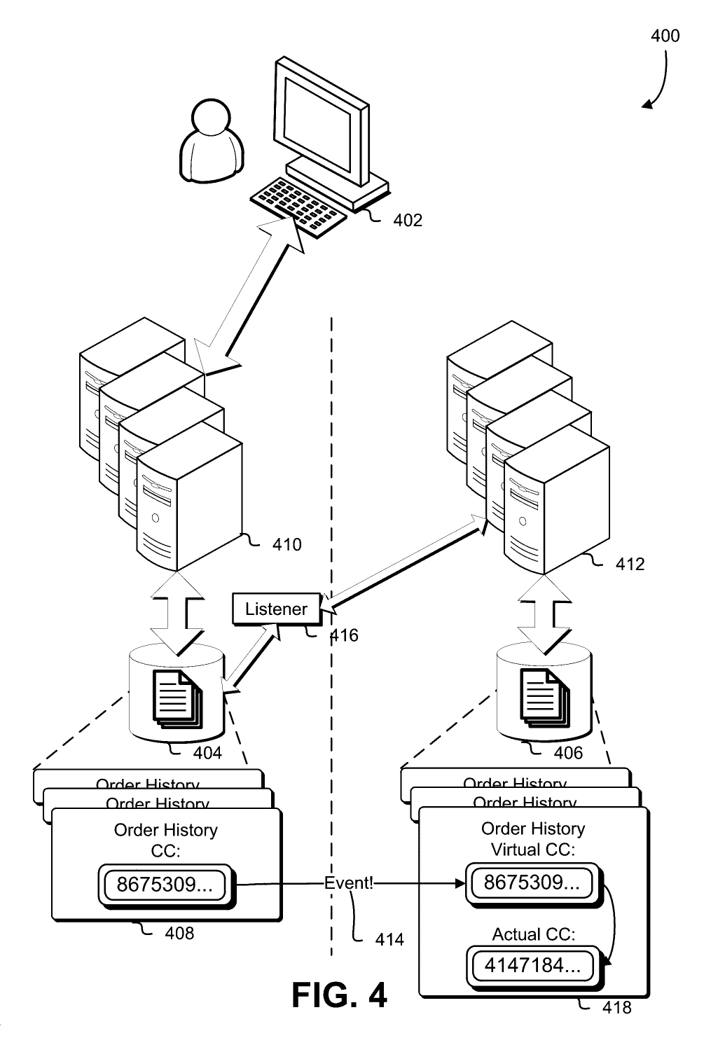

FIG. 4 illustrates implementation of a listener to synchronize merchant order updates with an external payment provider, in accordance with some embodiments. After an order is successfully submitted according to the above mentioned processes (e.g., as described in connection with FIGS. 1-3, various payment-related actions associated with the order, such as payment settlement, dispatching of the order, refunds, returns, and the like, may occur with respect to the virtual credit card previously submitted by the external payment provider, and not necessarily the remote user's actual method of payment. In some embodiments, a listener entity 416 is implemented to track the various states of an order with respect to the virtual credit card, and if such events occur, the listener 416 or other implemented or connected entity submits information regarding the events to the external payment provider 412 so as to synchronize such events with the actual payment instrument used, e.g., by a remote user 402. Additionally, various states may be inferred by certain events occurring in connection with the virtual credit card, such as date of dispatch, inventory levels (due to returns and the like), etc.

After ordering and initiating payment processing in a manner similar to that previously described, the remote user 402 interacts, in some embodiments, via a device with the merchant system 410 so as to manipulate the order, payment status, etc. Additionally, processes between the time of order and the time of dispatch (e.g., of ordered goods and services to the remote user 402) may cause various state changes, charges, and the like, to the virtual credit card used by the external payment provider 412 to initiate the order. For example, while a virtual credit card may be authorized at the time of order, it may not actually be charged until the time of dispatch of the ordered goods or services. Such states, and more generally a catalog of past orders 408 through the merchant system 410, are memorialized as records in merchant data store 404, which may be similar to the data stores described above in connection with FIG. 2. The external payment provider 412 also includes a data store 406 that stores an analogous catalog of past orders 418, and in some embodiments, analogous states to those stored within the merchant data store 404. The external payment provider data store 406 may additionally include information mapping the virtual credit card number(s) used for a given transaction to one or more identifiers, similar to those previously described, which may in some embodiments be the same identifiers used by the merchant system 410 to track past orders, e.g., 408.

The implemented listener 416 monitors events 414 occurring to, or in connection with, the virtual credit cards used for the orders. The listener 416 may be any entity, such as a script, binary, or other application comprising executable instructions and which is resident on a computing device, such as that of a merchant system or an external payment provider system, that, when executed by the computing device, is capable of polling, receiving periodic or event-driven information from, and/or querying the merchant data store 404 (or other entity associated therewith, such as an entity of the merchant system 410) for events relating to the virtual credit cards, such as charges, authorizations, chargebacks, refunds, captures, and the like. The information may be pushed to the computing device implementing the listener or, in some embodiments, queried at some interval or in connection with a related or unrelated event, and such information may be provided to the listener either asynchronously or synchronously relative to either the event or the query, as applicable. In response to receiving information relating to state changes or other events 414 on the virtual credit cards, the listener, via the implementing computing device, provides such information (or related information) to the external payment provider 412, so as to cause the external payment provider 412 to update the state of the associated order stored in the data store 406 on the external payment provider's end in accordance with the received information.

As the order history 418 on the external payment provider's end includes a mapping between the virtual credit card(s) used for the order(s) and the actual credit card to which the order amount was charged, such events may cause analogous actions to those taken within the merchant system 410. Such events may be direct, e.g., a refund back to the virtual credit card causing an analogous refund back to the associated actual credit card, or indirect, e.g., the charging of the virtual credit card implies to the listener 416 and/or the external payment provider 412 that the items in the order have dispatched to the remote user 402, and therefore the order may be regarded as closed in the record 418 stored in data store 406. As may be contemplated, various implications may be predetermined using, e.g., business rules, and may differ based on the specific implementation.

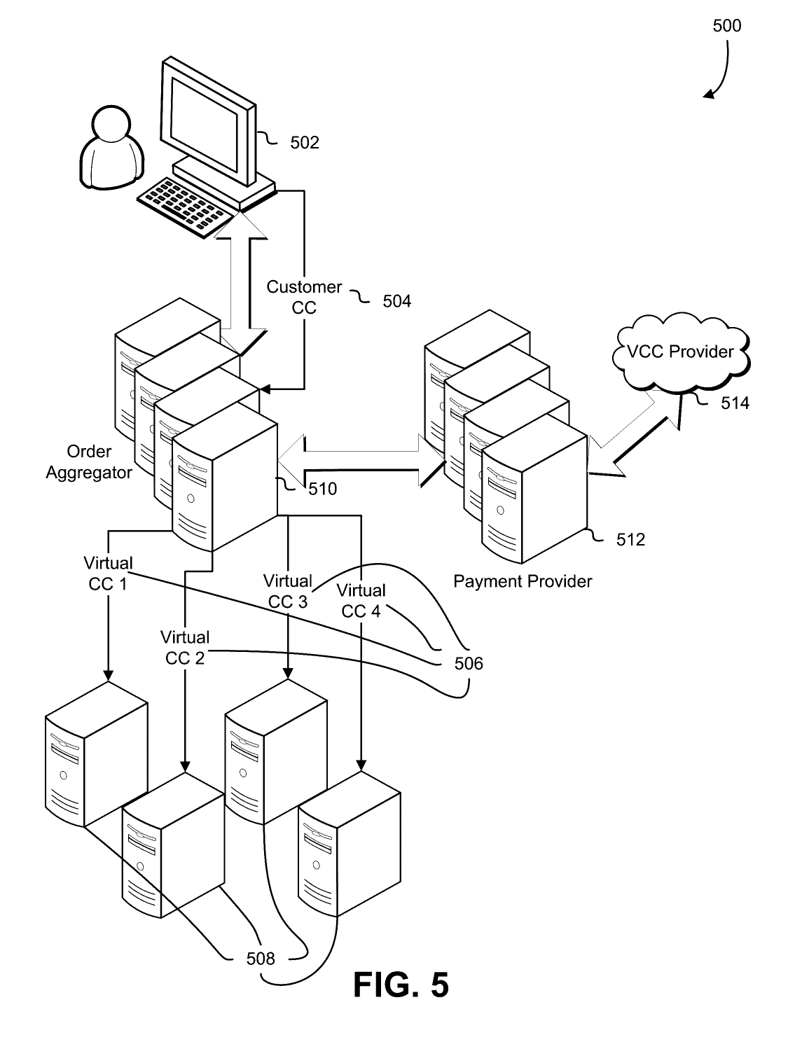

FIG. 5 illustrates integration of an external payment provider to facilitate order processing by an order aggregator in a multi-merchant environment, in accordance with some embodiments. The techniques described herein, and in particular in connection with FIGS. 1-4 above, may also be implemented in a multi-merchant environment. For example, a remote user 502 may interact with an order aggregator 510 or similar service and/or system that provides the remote user 502 with a single point of interaction for ordering goods and/or services from a plurality merchants 508, which may be similar to the merchants and merchant systems described elsewhere herein. The order aggregator, as with merchant system 508, may have its own set of verifications, order pipeline, and the like, and integration of an external payment provider 512 and a virtual credit card provider 514 may be performed using the techniques already described elsewhere herein.

It may be desirable for an order aggregator to use multiple virtual credit cards 506 to initiate sub-orders or other fulfillment tasks with the plurality of merchants 508 for various reasons, which include, for example, improved verification success rates (e.g., decreased likelihood of spurious fraud-based rejection relative to the use of one virtual credit across multiple merchants), conduction of the sub-orders in different currencies (e.g., the currencies preferred by the respective merchants), and the like. Thus, in some embodiments, an external payment provider 512 may provide multiple virtual credit cards for the order aggregator to use for a given parent order (e.g., by the remote user 502), without necessitating any more than a single method of payment (e.g., a customer's credit card 504) by the remote user 502 desiring to order items that are sub-ordered (e.g., auxiliary orders generated by the order aggregator to merchants providing the goods ordered, via the order aggregator 510, by the remote user 502) by the order aggregator 510 from the plurality of merchants 508. The multiple virtual credit cards used for such orders may all be mapped to the same customer credit card or other identifier, and a listener may monitor for events against all of the virtual credit cards used in such a transaction.

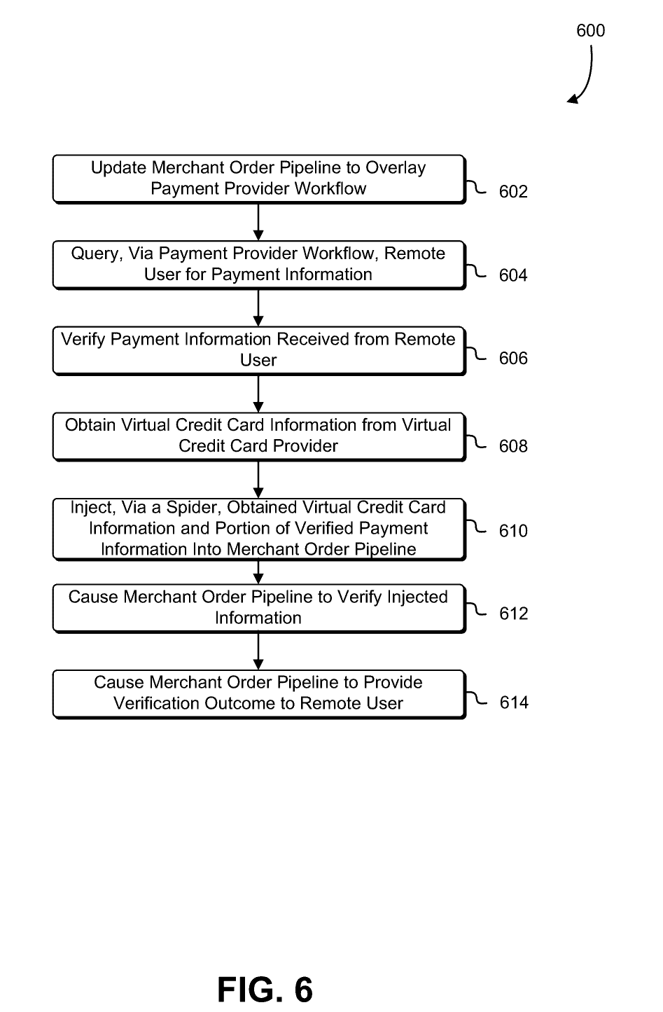

FIG. 6 illustrates an example process for processing order creation using an existing merchant order pipeline integrated with an external payment provider, in accordance with some embodiments. At step 602, a merchant order pipeline, such as variously described above in connection with FIGS. 1-5, is updated, such as by an external payment provider also as previously described, to incorporate the external payment provider's own payment workflow or pipeline. As previously discussed, such integration may occur by way of a script connected with the entry point to the merchant's order pipeline, and in some embodiments, the external payment provider's inputs may overlay that of the merchant's order pipeline.

At step 604, in response to an order/purchase request by a remote user or its associated device operating the merchant order pipeline of step 602, e.g., as would be initiated by the remote user clicking “buy” or “purchase” on the merchant's order pipepine, the external payment provider queries the remote user for information, including payment information, via the external payment provider's pipeline. As previously discussed, some of the requested information may be obtained via data transfer from the merchant's order pipeline. For example, a script or other entity operating on the merchant's order pipeline may transmit an electronic document or other data set including data already entered or otherwise applicable to the order from either (or both) the merchant's order pipeline, the remote user's device, or both, to the external payment provider's system, so as to enable the external payment provider's system to generate a second electronic document that includes that of the submitted electronic document. The second electronic document may render on the remote user's device and, for example, includes the information included in the first electronic document.

At step 606, the payment information received in connection with step 602 is verified by the external payment provider, and if such verification is successful, one or more virtual credit cards are obtained by the external payment provider from a virtual credit card provider at step 608. As previously mentioned, the external payment provider may interact with the virtual credit card provider via an API so as to obtain, either synchronously or asynchronously, the requested virtual credit card numbers.

At step 610, the virtual credit card(s) obtained in step 608, along with other information gathered regarding the payment (e.g., in connection with step 604 and verified in step 606) is submitted by the external payment provider back into the merchant's order pipeline via a spider, such as that described above in connection with FIGS. 1-5. As previously discussed, the spider may inject the requisite information into the appropriate page of the merchant's order pipeline without intervention from the remote user, and the page may not be visible to the remote user.

After such time as the requisite information is injected into the merchant order pipeline at step 610, at step 612, the spider causes the merchant order pipeline to verify the injected information, e.g., by emulating activation of a submission point (e.g., a “submit” button on the page). As previously discussed, the verification may be simplified so as to deduplicate verification operations already performed by the external payment provider. Finally, at step 614, if the order is successfully verified at step 612, the “success” page or other verification outcome is provided to the remote user, just as it would if the external payment provider had not been involved at all. In some embodiments, the “success” page is provided by the merchant system and, either directly or indirectly, is provided to the remote user's device to be rendered and thereby displayed to the remote user.

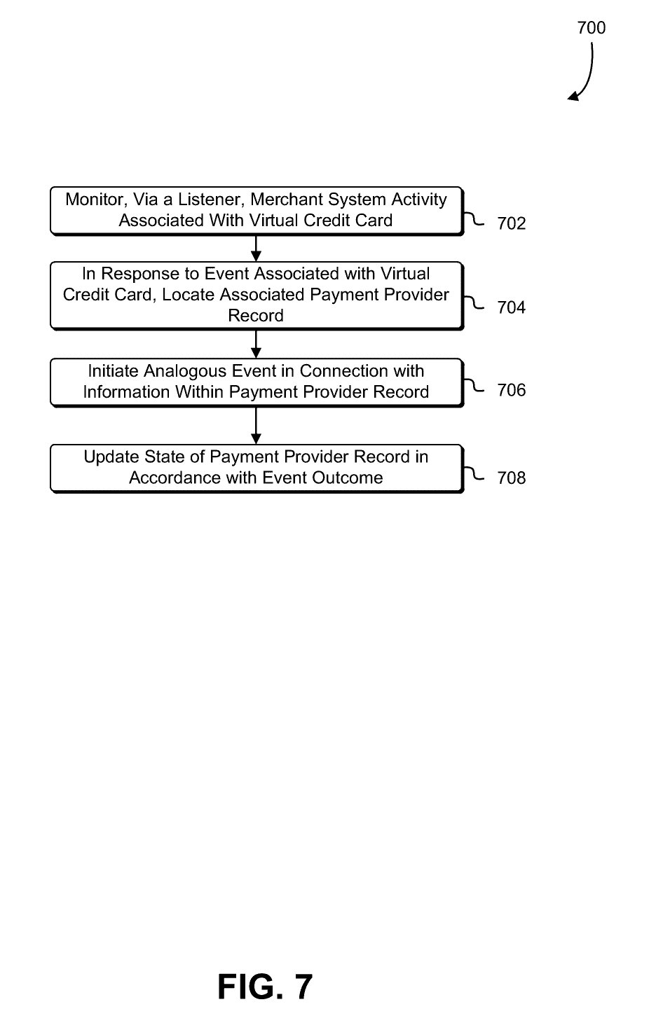

FIG. 7 illustrates an example process for monitoring merchant system activity to synchronize order updates with an integrated external payment provider, in accordance with some embodiments. At step 702, a listener entity, such as described in detail above, is implemented by a computing device so as to monitor a merchant system (or component(s) thereof, such as a data store) for activity associated with virtual credit cards used in orders placed using the techniques described herein, i.e., using an integrated external payment provider.

At step 704, in response to detecting an event associated with one or more virtual credit cards used in previously placed orders, the listener (or connected entity), via the implementing computing device, sends the information associated with the event to the external payment provider so as to induce the external payment provider to locate the associated record. As previously discussed, the virtual credit card and the actual credit card used may be associated with each other, e.g., by way of a common identifier, which may be used to identify a given order record within the data store of the external payment provider.

At step 706, after the associated record is located, the external payment provider takes appropriate actions in response to the event, which, as previously discussed, may include initiating charges or refunds to the customer's credit card, and/or updating internal records to reflect a state change for the order. After the update of step 706 is complete, the associated state in the associated record is updated at step 708 to reflect the outcome of the event.

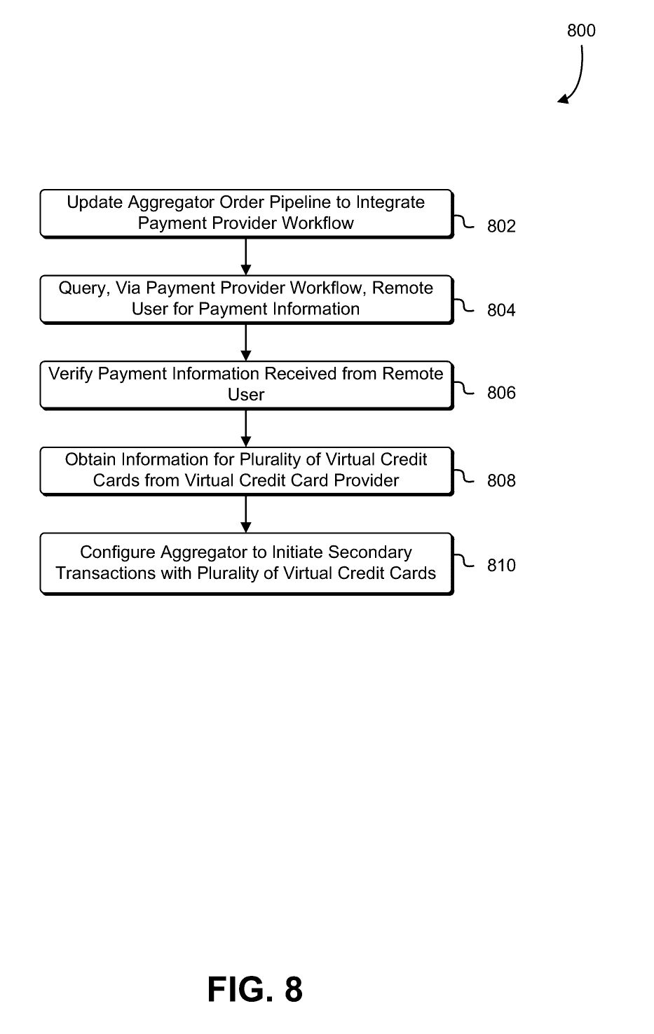

FIG. 8 illustrates an example process for issuing a plurality of virtual credit cards in connection with a multi-merchant environment in which an order aggregator operates, in accordance with some embodiments. At step 802, the aggregator order pipeline is updated to integrate the external payment provider's workflow in a similar manner as previously discussed, e.g., in connection with FIG. 1-7. As previously discussed, such integration may occur by way of a script connected with the entry point to the order aggregator's order pipeline, and in some embodiments, the external payment provider's inputs may overlay that of the aggregator's order pipeline.

At step 804, the external payment provider queries the remote user's device for information, including payment information, via the external payment provider's pipeline. As previously discussed, some of the requested information may be obtained via data transfer from the order aggregator's order pipeline. At step 806, the payment information received in connection with step 802 is verified by the external payment provider, and if such verification is successful, a plurality of virtual credit cards is obtained by the external payment provider from a virtual credit card provider at step 808.

At step 810, the order aggregator submits the plurality of virtual credit card numbers obtained in connection with step 808 to a plurality of merchants from which the order aggregator will submit sub-orders, in accordance with a multi-item order submitted by the remote user to the order aggregator. As previously discussed, such sub-orders may be individually conducted using different currencies or other parameters, so as to optimize the efficiency or reliability of the individual transactions for each sub-order.

FIG. 9 is an illustrative, simplified block diagram of an example computing device 1300 that may be used to practice at least one embodiment of the present disclosure. In various embodiments, the computing device 900 may be used to implement any of the systems illustrated herein and described above. For example, the computing device 900 may be configured for use as a data server, a web server, a portable computing device, a personal computer, or any electronic computing device. As shown in FIG. 9, the computing device 900 may include one or more processors 902 that may be configured to communicate with, and are operatively coupled to, a number of peripheral subsystems via a bus subsystem 904. The processors 902 may be utilized for the integrating one computing system with another, such as that of the external payment provider and the merchant, for monitoring and/or listening for events in various pipelines, and for generating electronic documents (e.g., webpages or other user interfaces) in embodiments of the present disclosure. These peripheral subsystems may include a storage subsystem 906, comprising a memory subsystem 908 and a file storage subsystem 910, one or more user interface input devices 912, one or more user interface output devices 914, and a network interface subsystem 916. Such storage subsystem 906 may be used for temporary or long-term storage of information such as details associated with orders described in the present disclosure, databases of historical records described in the present disclosure, and storage of mappings between virtual credit cards and customer credit cards.

The bus subsystem 9904 may provide a mechanism for enabling the various components and subsystems of computing device 900 to communicate with each other as intended. Although the bus subsystem 904 is shown schematically as a single bus, alternative embodiments of the bus subsystem may utilize multiple busses. The network interface subsystem 916 may provide an interface to other computing devices and networks. The network interface subsystem 916 may serve as an interface for receiving data from, and transmitting data to, other systems from the computing device 900. For example, the network interface subsystem 916 may enable a data technician or remote user to connect the device to a wireless network such that the data technician or remote user may be able to transmit and receive data while in a remote location, such as a user or merchant data center. The bus subsystem 904 may be utilized for communicating data, such as order details, credit card numbers, and so on between various systems and devices (such as that of the remote user, the systems and subsystems of the merchant and/or the external payment provider, and the like).

The user interface input devices 912 may include one or more user input devices, such as a keyboard, pointing devices such as an integrated mouse, trackball, touchpad, or graphics tablet, a scanner, a barcode scanner, a touch screen incorporated into the display, audio input devices such as voice recognition systems, microphones, and other types of input devices. In general, use of the term “input device” is intended to include all possible types of devices and mechanisms for inputting information to the computing device 900. User interface output devices 914 may include a display subsystem, a printer, or non-visual displays such as audio output devices, etc. The display subsystem may be a cathode ray tube (CRT), a flat-panel device such as a liquid crystal display (LCD), light emitting diode (LED) display, or a projection or other display device. In general, use of the term “output device” is intended to include all possible types of devices and mechanisms for outputting information from the computing device 900. The output device(s) 914 may be used, for example, to present user interfaces to facilitate user interaction with applications performing processes described herein and variations therein, when such interaction may be appropriate.

The storage subsystem 906 may provide a computer-readable storage medium for storing the basic programming and data constructs that may provide the functionality of at least one embodiment of the present disclosure. The applications (programs, code modules, instructions) that, when executed by one or more processors, may provide the functionality of one or more embodiments of the present disclosure, and may be stored in the storage subsystem 906. These application modules or instructions may be executed by the one or more processors 902. The storage subsystem 1306 may additionally provide a repository for storing data used in accordance with the present disclosure. The storage subsystem 906 may comprise a memory subsystem 908 and a file/disk storage subsystem 910.

The memory subsystem 908 may include a number of memories including a main random access memory (RAM) 918 for storage of instructions and data during program execution and a read only memory (ROM) 920 in which fixed instructions may be stored. The file storage subsystem 910 may provide a non-transitory persistent (non-volatile) storage for program and data files, and may include a hard disk drive, a floppy disk drive along with associated removable media, a Compact Disk Read Only Memory (CD-ROM) drive, an optical drive, removable media cartridges, and other like storage media.

The computing device 900 may include at least one local clock 924. The local clock 924 may be a counter that represents the number of ticks that have transpired from a particular starting date and may be located integrally within the computing device 900. The local clock 924 may be used to synchronize data transfers in the processors for the computing device 900 and all of the subsystems included therein at specific clock pulses and may be used to coordinate synchronous operations between the computing device 900 and other systems in a data center. In one embodiment the local clock 924 is an atomic clock. In another embodiment, the local clock is a programmable interval timer.

The computing device 900 may be of various types including a portable computer device, tablet computer, a workstation, or any other device described below. Additionally, the computing device 900 may include another device that may be connected to the computing device 900 through one or more ports (e.g., USB, a headphone jack, Lightning connector, etc.). The device that may be connected to the computing device 900 may include a plurality of ports configured to accept fiber-optic connectors. Accordingly, this device may be configured to convert optical signals to electrical signals that may be transmitted through the port connecting the device to the computing device 900 for processing. Due to the ever-changing nature of computers and networks, the description of the computing device 900 depicted in FIG. 9 is intended only as a specific example for purposes of illustrating the preferred embodiment of the device. Many other configurations having more or fewer components than the system depicted in FIG. 9 are possible.

The specification and drawings are, accordingly, to be regarded in an illustrative rather than a restrictive sense. It will, however, be evident that various modifications and changes may be made thereunto without departing from the broader spirit and scope of the invention as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions and equivalents falling within the spirit and scope of the invention, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including” and “containing” are to be construed as open-ended terms (i.e., meaning “including, but not limited to,”) unless otherwise noted. The term “connected,” when unmodified and referring to physical connections, is to be construed as partly or wholly contained within, attached to or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present.

Operations of processes described herein can be performed in any suitable order unless otherwise indicated herein or otherwise clearly contradicted by context. Processes described herein (or variations and/or combinations thereof) may be performed under the control of one or more computer systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory.

The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Embodiments of this disclosure are described herein, including the best mode known to the inventors for carrying out the invention. Variations of those embodiments may become apparent to those of ordinary skill in the art upon reading the foregoing description. The inventors expect skilled artisans to employ such variations as appropriate and the inventors intend for embodiments of the present disclosure to be practiced otherwise than as specifically described herein. Accordingly, the scope of the present disclosure includes all modifications and equivalents of the subject matter recited in the claims appended hereto as permitted by applicable law. Moreover, any combination of the above-described elements in all possible variations thereof is encompassed by the scope of the present disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

1. A computer-implemented method, comprising:
under the control of one or more computer systems configured with executable instructions,
in response to receiving, via a programmatic interface, information of an activation of an external payment provider pipeline, the activation related to an order placed via an order pipeline, processing the order by at least:
generating, from the information received in connection with the activation, a first set of customer information that is compatible with the external payment provider pipeline, the first set of customer information including at least one or more values specifying a plurality of attributes related to the order; and
injecting the first set of customer information into the external payment provider pipeline by at least populating one or more data fields of the external payment provider pipeline with the first set of customer information;
programmatically presenting one or more interfaces of the external payment provider pipeline via the order pipeline so as to generate a second set of customer information via the order pipeline;
processing the first set and second set of customer information to obtain, from a virtual credit card provider, at least one virtual credit card number;
injecting, via a spider, the virtual credit card number into the order pipeline via an entry point of the order pipeline, the entry point being preconfigured to receive the virtual credit card number; and
causing, via the spider, the order pipeline to process the order using at least the injected virtual credit card number.

2. The computer-implemented method of claim 1, further comprising listening, via a listener, for order events related to the order by at least tracking payment events related to the virtual credit card number.

3. The computer-implemented method of claim 2, wherein the listener causes the external payment provider pipeline to update order states for the order in connection with the order events.

4. The computer-implemented method of claim 1, wherein the one or more interfaces of the external payment provider pipeline are programmatically presented so as to be visually overlaid on a user interface of the order pipeline.

5-20. (canceled)

21. The computer-implemented method of claim 1, further comprising rendering a user interface to receive the second set of customer information, the user interface being one of the one or more interfaces.

22. The computer-implemented method of claim 1, wherein the first set of information is gathered via the order pipeline.

23. The computer-implemented method of claim 1, wherein the external payment provider pipeline is managed by a computer system different from the one or more computer systems.

24. The computer-implemented method of claim 1, wherein the spider is an automated process.

25. A system, comprising:
at least one processor; and
memory including instructions that, as a result of execution by the at least one processor, cause the system to:
in response to receiving, via a programmatic interface, information of an activation of an external payment provider pipeline, the activation related to an order placed via an order pipeline, process the order by at least:
generating, from the information received in connection with the activation, a first set of customer information that is compatible with the external payment provider pipeline, the first set of customer information including at least one or more values specifying a plurality of attributes related to the order; and
injecting the first set of customer information into the external payment provider pipeline by at least populating one or more data fields of the external payment provider pipeline with the first set of customer information;
programmatically present one or more interfaces of the external payment provider pipeline via the order pipeline so as to generate a second set of customer information via the order pipeline;
process the first set and second set of customer information to obtain, from a virtual credit card provider; at least one virtual credit card number;
inject, via a spider, the virtual credit card number into the order pipeline via an entry point of the order pipeline, the entry point being preconfigured to receive the virtual credit card number; and
cause, via the spider, the order pipeline to process the order using at least the injected virtual credit card number.

26. The system of claim 25, wherein the one or more interfaces comprise a graphical user interface.

27. The system of claim 25, wherein the instructions cause the computer system to implement a listener that detects order an order event related to the order by at least tracking payment events related to the virtual credit card number.

28. The system of claim 27, wherein the listener causes the external payment provider pipeline to update order states for the order in connection with the order events.

29. The system of claim 27, wherein the listener polls for updates related to the one or more virtual credit cards to detect the order event.

30. The system of claim 25, wherein the spider is a script.

31. The system of claim 25, wherein the one or more interfaces of the external payment provider pipeline are programmatically presented so as to be visually overlaid on a user interface associated with the order pipeline.

32. A non-transitory computer-readable storage medium having stored thereon instructions that, as a result of execution by at least one processor of a computer system, cause the computer system to:
in response to receiving, via a programmatic interface, information of an activation of an external payment provider pipeline, the activation related to an order placed via an order pipeline, process the order by at least:
generating, from the information received in connection with the activation, a first set of customer information that is compatible with the external payment provider pipeline, the first set of customer information including at least one or more values specifying a plurality of attributes related to the order; and
injecting the first set of customer information into the external payment provider pipeline by at least populating one or more data fields of the external payment provider pipeline with the first set of customer information;
programmatically present one or more interfaces of the external payment provider pipeline via the order pipeline so as to generate a second set of customer information via the order pipeline;
process the first set and second set of customer information to obtain, from a virtual credit card provider, at least one virtual credit card number;
inject, via a spider, the virtual credit card number into the order pipeline via an entry point of the order pipeline, the entry point being preconfigured to receive the virtual credit card number; and
cause, via the spider, the order pipeline to process the order using at least the injected virtual credit card number.

33. The non-transitory computer-readable storage medium of claim 32, wherein the spider is an automated process that is executed on another computer system that is physically separate from the computer system.

34. The non-transitory computer-readable storage medium of claim 32, wherein the instructions further cause the computer system to implement a listener that detects order an order event related to the order by at least tracking payment events related to the virtual credit card number.

35. The non-transitory computer-readable storage medium of claim 34, wherein the listener causes the external payment provider pipeline to update order states for the order in connection with the order events.

36. The non-transitory computer-readable storage medium of claim 32, wherein the one or more interfaces of the external payment provider pipeline are programmatically presented so as to be visually overlaid on a user interface associated with the order pipeline.

37. The non-transitory computer-readable storage medium of claim 32, wherein the spider translates data that encodes the virtual credit card number from a first data format to a second data format.
